(19) United States
(12) Patent Application Publication
(10) Pub. No.: US 2001/0045750 A1
(43) Pub. Date: Nov. 29, 2001

(54) Gravity-sensitive latch

(76) Inventors: Lianli Ji, Westchester, PA (US); Robert Straka, Pheonixville, PA (US); Gerry Clisham, Westchester, PA (US)

Correspondence Address: H. Steve Ngo, Paul and Paul, 2900 Two Thousand Market St., Philadelphia, PA, 19103, US

(21) Appl. No.: 09/801,489

(22) Filed: Mar. 7, 2001

Related U.S. Application Data
(60) Provisional application No. 60/188,287, filed on Mar. 7, 2000.

(51) Int. Cl. E05C 19/10

(52) U.S. Cl. 292/131

(57) ABSTRACT

The present invention is a gravity-sensitive latch. The latch includes a pendulum pivotally secured between the actuating button or handle and the pawl. When the latch is in a first position, gravity acting on the pendulum rotates the pendulum so that it abuts the button or handle, permitting actuation of the latch. When the latch is in a second orientation, gravity acting on the pendulum rotates the pendulum away from the button or handle, thereby preventing actuation of the latch. The latch may use a wide variety of buttons, handles, or pawl/keeper combinations.

### BACKGROUND OF THE INVENTION

1. Field of the Invention

The invention is a gravity-sensitive latch. The latch is operable when in a first orientation, secured in its closed position when in its second orientation.

2. Description of the Related Art

Although other inventors have proposed various means for selectively permitting and preventing opening of a latch, the present inventor is unaware of any other publicly known latches that provide the option of using gravity for this purpose.

Some presently existing latches incorporate a catch fitting within a T-shaped slot in the handle. When the latch is in the closed position, the catch fits within the narrow portion of the T-shaped slot, thereby preventing the handle from being actuated to open the latch. To open the latch, the catch must first be moved to the wide portion to the T-shaped slot. The catch must be moved manually, and does not rely on gravity for automatic movement, unlike the present invention.

While not limited to such use, the present invention is directed towards lids attached to a center console of an automobile. Such consoles sometimes pivot between a horizontal position providing access to the console, and a vertical position wherein the console is contained within the seat back. An example of such a latch is pictured in Southco, Inc. Catalog No. 48 NA, 1998, p. G-10. This latch does not permit the use of gravity to selectively permit or prevent opening of the latch.

Other latches intended for use on automobile consoles use a push-button actuator to control a pair of hooks that engage a keeper in a scissors-like manner. Pushing the button pushes the hooks apart, and releasing the button allows the hooks to come together.

None of the above-referenced publications, taken singly or in combination, is seen to describe the present invention as claimed.

### SUMMARY OF THE INVENTION

The invention is a gravity-sensitive latch. When the latch is in a first orientation, such as horizontal, the latch may be actuated. When the latch is in a second orientation, preferably vertical, the latch cannot be actuated. The latch includes a housing, a handle or button, a pendulum, a pawl dimensioned and configured to engage a keeper, and means for connecting the pendulum to the pawl.

The critical feature of all embodiments of the present invention is the pendulum, because the pivoting of the pendulum in response to gravity permits or prohibits actuation of the latch. A preferred and suggested pendulum is triangular in shape, having a connection corner pivotally secured to a pawl assembly, a weighted corner, and an abutment corner dimensioned and configured to abut a corresponding surface of the handle or button.

A housing for a first embodiment of the present invention is preferably rectangular and elongated, with the sides having the largest surface area forming the top and bottom. The top is substantially open within the housing's front portion, and the bottom is substantially open within the rear portion. The housing includes a front end dimensioned and configured to receive a button, preferably including a central aperture and a pair of slots on either side.

The button includes a body having a front surface. A short, wide shaft protrudes from the rear of the button, and is dimensioned and configured to fit within the central aperture of the housing's front. The button includes means for securing to the housing, preferably in the form of flanges on either side of the shaft, dimensioned and configured to fit within the slots on the housing's front. When the button is installed on a latch, the end of the central shaft will abut the abutment corner of the pendulum. The button is spring-biased away from the housing, towards its forward position.

The pendulum is pivotally secured to a connecting rod, which is in turn secured to a pawl. The weighted corner of the pendulum extends upward. A preferred and suggested pawl is configured as a box with a bottom surface having a pawl-engaging aperture. The pawl is secured to the housing by a pawl-retaining bracket, with the pawl-retaining bracket having a second pawl-engaging aperture substantially the same as the pawl's aperture, and located adjacent to this aperture. The pawl reciprocates between a latched position wherein the two apertures are slightly offset from each other, and an unlatched position wherein the apertures are aligned with each other. The pawl is spring-biased towards its latched position. A second spring preferably extends downward from the top of the pawl's box.

A keeper corresponding to the first embodiment of the latch will typically be a cylindrical shaft having a channel around its upper end. The upper end or tip of the keeper has a tapered configuration. Typically, the latch will be secured to a lid, and the keeper will be secured to the frame surrounding the lid.

Latching the latch is accomplished by inserting the keeper into the two apertures in the pawl and flange, causing the tapered tip of the keeper to bias the pawl towards its unlatched position, allowing the keeper to enter the pawl. The pawl's upper spring is thereby compressed. Once the keeper's channel is even with the pawl's bottom surface, the pawl moves under spring pressure towards its latched position, thereby trapping the keeper's channel between the edge of the pawl's aperture and the edge of the pawl retaining flange's aperture.

When the latch is in its horizontal position, the pendulum abuts the central shaft of the button, so that a rearward push on the button pushes rearward on the pendulum. The connecting rod and pawl are thereby also pushed rearward, releasing the keeper's channel from between the pawl aperture and pawl flange's aperture. The pawl's top spring then pushes the keeper out of the latch.

When the latch is in its vertical position, the pendulum pivots away from the button through gravity acting on the pendulum's weighted corner. When the button is pressed rearward, it is thereby prevented from actuating the latch. Rotating the latch into a horizontal position will again pivot the pendulum into engagement with the button, permitting actuation of the latch.

A second embodiment of a latch according to the present invention uses a handle that is pulled to actuate the latch, instead of a button to be pushed. The handle is preferably L-shaped when viewed from either side. The handle includes means for pivotally securing to the housing, and a rearward-projecting flange for abutting the pendulum. The handle preferably includes a stop to prevent travel beyond the desired range of motion. The handle pivots between a latched position and an unlatched position, and is spring-biased towards its latched position.

The pendulum is pivotally secured to a pawl-retaining arm. The pawl-retaining arm is pivotally secured to the housing at its end adjacent to the pawl, permitting it to pivot between a latched position and an unlatched position. The pawl-retaining arm is spring-biased towards its latched position, wherein its opposite end engages a pawl.

The pawl is pivotally secured to the housing. The pawl includes a pair of arms extending towards the handle, and a third arm extending rearward. The rearward arm is dimensioned and configured to engage the pawl-retaining arm. The two forward arms are dimensioned and configured to secure a keeper, which will typically be an inverted U-shaped wire or rod. The pawl pivots between a latched position wherein the two forward arms are substantially horizontal, and an unlatched position wherein the two forward arms point downward. The pawl is spring-biased towards its unlatched position The housing includes a slot dimensioned and configured to receive a keeper.

Typically, the latch will be secured to a lid, and the keeper will be secured to a frame surrounding the lid. When the lid is closed and the keeper enters the housing, it engages the upper forward arm of the pawl, pushing the pawl towards its horizontal position. As the pawl rotates, the pawl's rearward arm pushes the pawl retaining arm rearward, permitting the pawl to rotate into a horizontal position. Once the pawl is horizontal, the pawl-retaining arm moves forward under spring pressure, to a position under the pawl's rear arm. The keeper is thereby secured between the pawl's upper and lower front arms, and by the slot in the housing.

The unlatching of the latch is controlled by the position of the pendulum. When the latch is in its horizontal position, the pendulum abuts the handle, so that an upward pull on the handle will push the pendulum rearward. The paw-retaining arm will thereby also be pushed rearward, releasing the pawl to rotate under spring pressure towards its unlatched position. The keeper can then exit the latch. When the latch is in its vertical position, the pendulum rotates away from the handle, so that a pull on the handle does not push rearward on the pendulum. Rotating the latch back to its horizontal position causes the pendulum to again rotate so that it abuts the handle, permitting actuation of the latch.

A third embodiment of the invention is actuated by depressing a button. The button is pivotally secured to the housing, and includes a flange for abutting the pendulum. The button is spring-biased forward, away from the housing. The pendulum is secured directly to the upper end of a pawl. The pawl of the third embodiment is a vertically oriented plate having a lower end dimensioned and configured to engage a keeper. The pawl is pivotally secured along its central section to the housing, so that a rearward push on the pawl pushes the pawl's lower end forward towards its unlatched position. The pawl is spring-biased towards its rearward latched position.

Typically, the latch will be secured to a lid, and the keeper will be secured to a frame surrounding the lid. A preferred keeper is a plate having an opening dimensioned and configured to receive the pawl. When the latch is closed, the edge of the pawl's ramped lower end strikes the keeper, pushing the lower end of the pawl forward and allowing the pawl to enter the keeper's opening. Once the pawl's lower end clears the edge of the keeper, the pawl returns to its latched position under spring pressure, latching the latch.

Unlatching of the latch is controlled by the position of the pendulum. When the latch is in its horizontal position, the pendulum is rotated to engage the button. Depressing the button will therefore push rearward on the pendulum and the upper end of the pawl, unlatching the latch. When the latch is in a vertical orientation, the pendulum pivots away from the button, so that pressing the button will not unlatch the latch. Rotating the latch to its horizontal orientation will again rotate the pendulum to abut the button, permitting actuation of the latch.

The latch may include a lock for preventing actuation of the latch regardless of its orientation. A preferred and suggested lock includes a standard lock plug having a pin at its rear end, and a locking arm. The locking arm includes a diagonal slot at one end, dimensioned and configured to receive the pin of the lock plug. The opposite end of the locking arm includes a ramp dimensioned and configured to push the pendulum out of engagement with the button. Turning the key in the lock plug rotates the pin, thereby pushing the locking arm under the pendulum, moving the pendulum away from the button. Turning the key in the opposite direction slides the locking arm away from the pendulum, thereby removing the locking arm from engagement with the pendulum and permitting free rotation of the pendulum.

While not limited to such use, a gravity-sensitive latch is particularly useful for the center consoles of automobiles. Such consoles can sometimes rotate into a vertical position to provide additional seating space, or a horizontal position to provide access to storage space within the console. When the console is vertical, it is desirable to prevent accidental opening of the storage compartment therein. When the latch is horizontal, it is desirable to permit access to the storage compartment. A gravity-sensitive latch performs both functions automatically.

It is therefore an object of the present invention to provide a latch that automatically permits actuation when in a first orientation, and precludes actuation when in a second orientation.

It is another object of the present invention to provide a gravity-sensitive latching mechanism useable with a wide variety of buttons and/or handles.

It is a third object of the present invention to provide a gravity-sensitive latching mechanism permitting the use of a wide variety of pawl/keeper combinations.

These and other objects of the invention will become apparent through the following description and claims.

### BRIEF DESCRIPTION OF THE DRAWINGS

FIG. 1 is a top perspective view of a first embodiment of a gravity-sensitive latch according to the present invention.

FIG. 2 is a bottom perspective view of a first embodiment of a gravity-sensitive latch according to the present invention.

FIG. 3 is a partially exploded, top perspective view of a first embodiment of a gravity-sensitive latch according to the present invention.

FIG. 4 is an exploded side view of a pawl and keeper assembly for a first embodiment of a gravity-sensitive latch according to the present invention.

FIG. 5 is an exploded perspective view of a pawl and keeper assembly for a first embodiment of a gravity-sensitive latch according to the present invention.

FIG. 6 is a perspective view of a housing for a first embodiment of a gravity-sensitive latch according to the present invention.

FIG. 7 is a front view of a housing for a first embodiment of a gravity-sensitive latch according to the present invention.

FIG. 8 is a bottom view of a housing for a first embodiment of a gravity-sensitive latch according to the present invention.

FIG. 9 is a perspective view of a button for a first embodiment of a gravity-sensitive latch according to the present invention.

FIG. 10 is a perspective view of a spring for a first embodiment of a gravity-sensitive latch according to the present invention.

FIG. 11 is a perspective view of a connecting rod for a first embodiment of a gravity-sensitive latch according to the present invention.

FIG. 12 is a perspective view of a pendulum for all embodiments of a gravity-sensitive latch according to the present invention.

FIG. 13 is a bottom view of a pendulum for all embodiments of a gravity-sensitive latch according to the present invention.

FIG. 14 is a back view of a pendulum for all embodiments of a gravity-sensitive latch according to the present invention.

FIG. 15 is a top perspective view of a second embodiment of a gravity-sensitive latch according to the present invention.

FIG. 16 is an exploded top perspective view of a second embodiment of a gravity-sensitive latch according to the present invention.

FIG. 17 is a perspective view of a housing for a second embodiment of a gravity-sensitive latch according to the present invention.

FIG. 18 is a top view of a housing for a second embodiment of a gravity-sensitive latch according to the present invention.

FIG. 19 is a bottom view of a housing for a second embodiment of a gravity-sensitive latch according to the present invention.

FIG. 20 is a back view of a housing for a second embodiment of a gravity-sensitive latch according to the present invention.

FIG. 21 is a side view of a housing for a second embodiment of a gravity-sensitive latch according to the present invention.

FIG. 22 is a front view of a housing for a second embodiment of a gravity-sensitive latch according to the present invention.

FIG. 23 is a perspective view of a handle for a second embodiment of a gravity-sensitive latch according to the present invention.

FIG. 24 is a side view of a handle for a second embodiment of a gravity-sensitive latch according to the present invention.

FIG. 25 is a back view of a handle for a second embodiment of a gravity-sensitive latch according to the present invention.

FIG. 26 is a perspective view of a pawl-retaining arm for a second embodiment of a gravity-sensitive latch according to the present invention.

FIG. 27 is a back view of a pawl-retaining arm for a second embodiment of a gravity-sensitive latch according to the present invention.

FIG. 28 is a bottom view of a pawl-retaining arm for a second embodiment of a gravity-sensitive latch according to the present invention.

FIG. 29 is a perspective view of a pawl for a second embodiment of a gravity-sensitive latch according to the present invention.

FIG. 30 is a side view of a pawl for a second embodiment of a gravity-sensitive latch according to the present invention.

FIG. 31 is a perspective view of a pawl spring for a second embodiment of a gravity-sensitive latch according to the present invention.

FIG. 32 is a perspective view of a spring for a pawl-retaining arm for a second embodiment of a gravity-sensitive latch according to the present invention.

FIG. 33 is a perspective view of a pin for a second embodiment of a gravity-sensitive latch according to the present invention.

FIG. 34 is a side perspective view of a third embodiment of a gravity-sensitive latch according to the present invention, showing the pendulum abutting the button.

FIG. 35 is a side perspective view of a third embodiment of a gravity-sensitive latch according to the present invention, showing the pendulum rotated to disengage from the button.

FIG. 36 is a front perspective view of a third embodiment of a gravity-sensitive latch according to the present invention, showing the pendulum abutting the button.

FIG. 37 is a side perspective view of a third embodiment of a gravity-sensitive latch according to the present invention, showing the pendulum rotated to disengage from the button.

FIG. 38 is a rear perspective view of a third embodiment of a gravity-sensitive latch according to the present invention, showing the pendulum rotated to disengage from the button.

FIG. 39 is an exploded top perspective view of a third embodiment of a gravity-sensitive latch according to the present invention, including a lock plug.

FIG. 40 is an exploded top perspective view of a third embodiment of a gravity-sensitive latch according to the present invention, not including a lock plug.

FIG. 41 is a rear perspective view of a button for a third embodiment of a gravity-sensitive latch according to the present invention.

FIG. 42 is a front view of a button for a third embodiment of a gravity-sensitive latch according to the present invention.

FIG. 43 is a perspective view of a housing for a third embodiment of a gravity-sensitive latch according to the present invention.

FIG. 44 is a top view of a housing for a third embodiment of a gravity-sensitive latch according to the present invention.

FIG. 45 is a back view of a housing for a third embodiment of a gravity-sensitive latch according to the present invention.

FIG. 46 is a side view of a housing for a third embodiment of a gravity-sensitive latch according to the present invention.

FIG. 47 is a front view of a housing for a third embodiment of a gravity-sensitive latch according to the present invention.

FIG. 48 is a bottom view of a housing for a third embodiment of a gravity-sensitive latch according to the present invention.

FIG. 49 is a perspective view of a locking arm for a third embodiment of a gravity-sensitive latch according to the present invention.

FIG. 50 is a back view of a locking arm for a third embodiment of a gravity-sensitive latch according to the present invention.

FIG. 51 is a bottom view of a locking arm for a third embodiment of a gravity-sensitive latch according to the present invention.

FIG. 52 is a perspective view of a pawl for a third embodiment of a gravity-sensitive latch according to the present invention.

FIG. 53 is a side view of a pawl for a third embodiment of a gravity-sensitive latch according to the present invention.

FIG. 54 is a perspective view of a lock plug for a third embodiment of a gravity-sensitive latch according to the present invention.

FIG. 55 is a front view of a lock plug for a third embodiment of a gravity-sensitive latch according to the present invention.

FIG. 56 is a perspective view of a spring for a third embodiment of a gravity-sensitive latch according to the present invention.

FIG. 57 is a perspective view of a pivot rod for a third embodiment of a gravity-sensitive latch according to the present invention.

Like reference numbers denote like elements throughout the drawings.

### DETAILED DESCRIPTION OF THE PREFERRED EMBODIMENTS

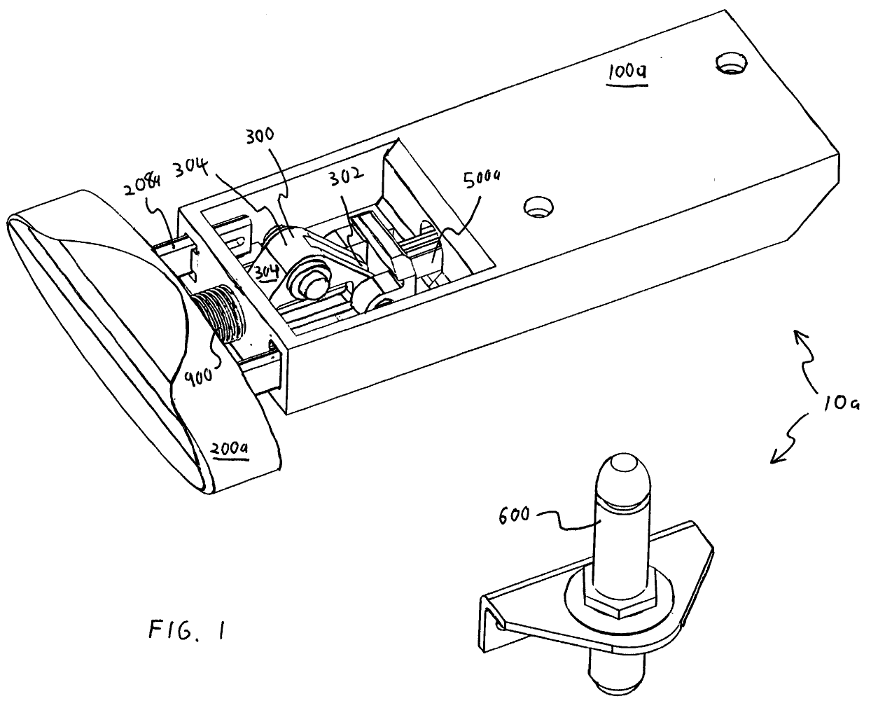

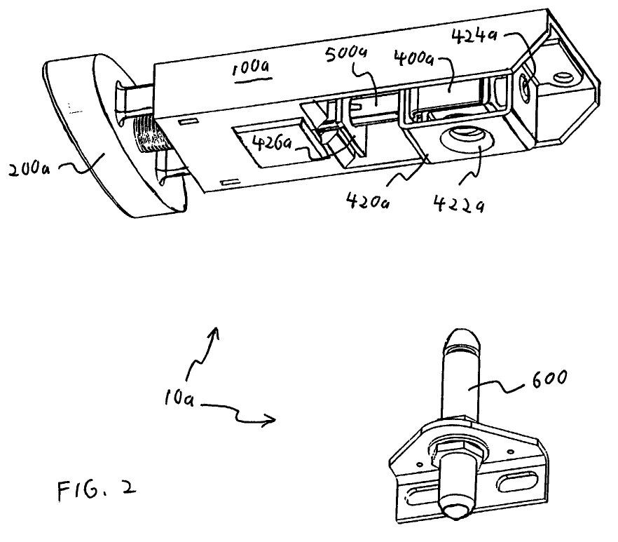

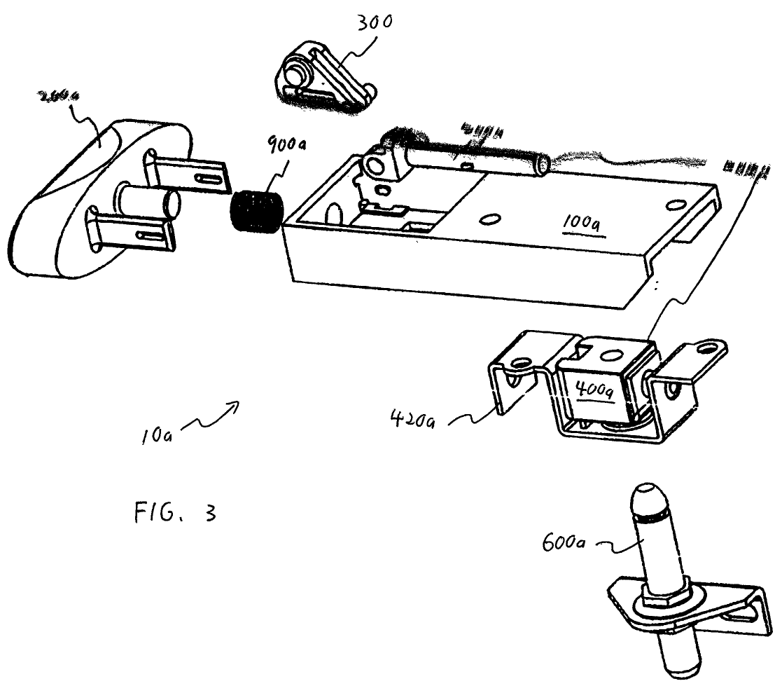

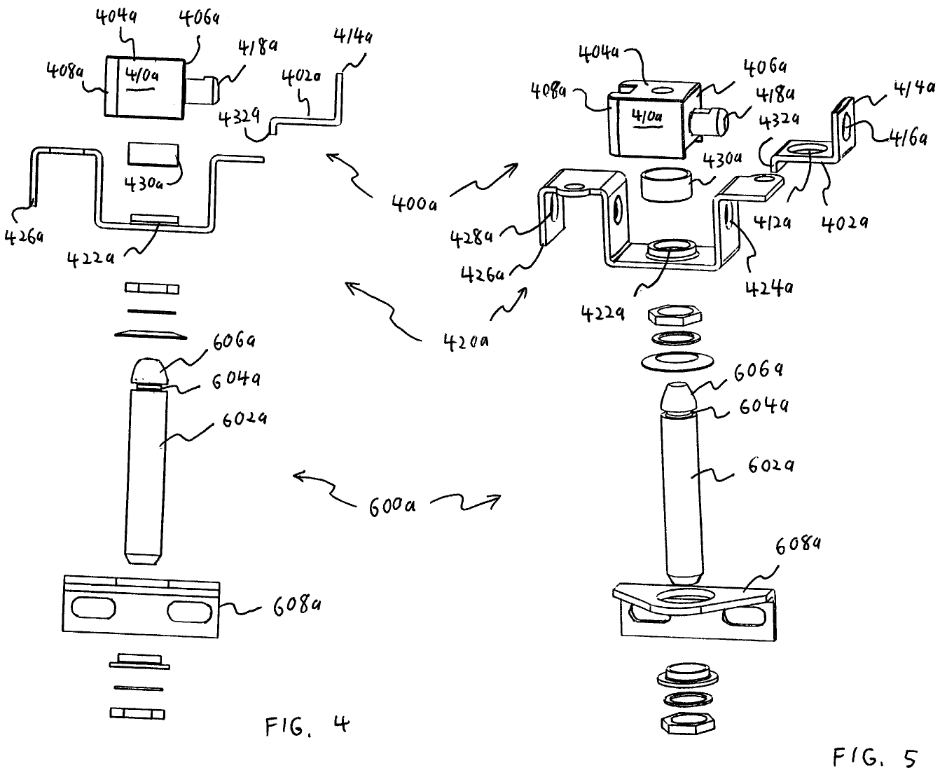

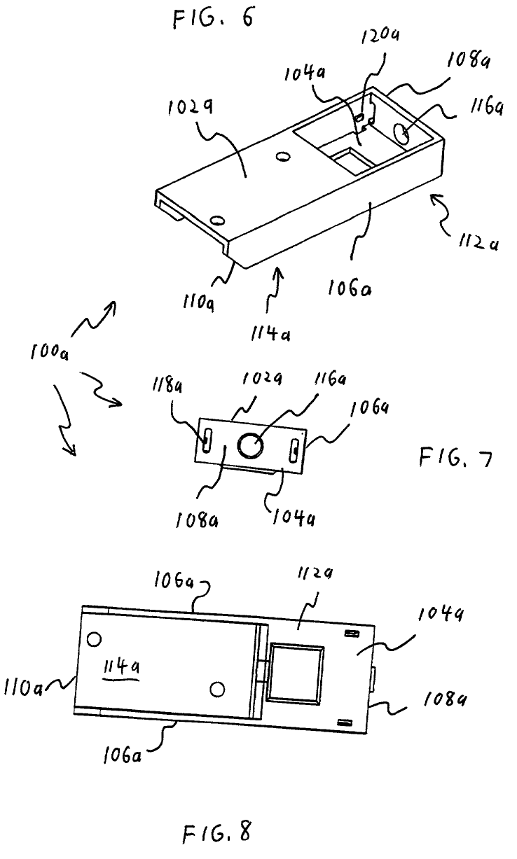

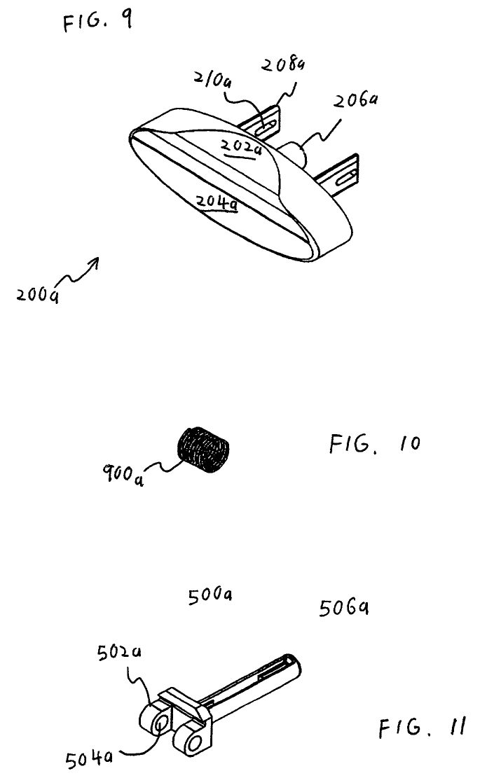

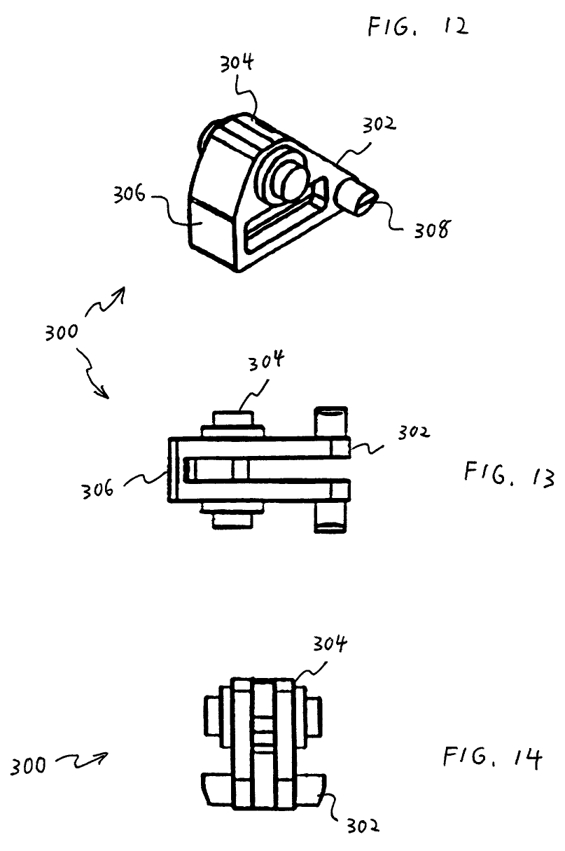

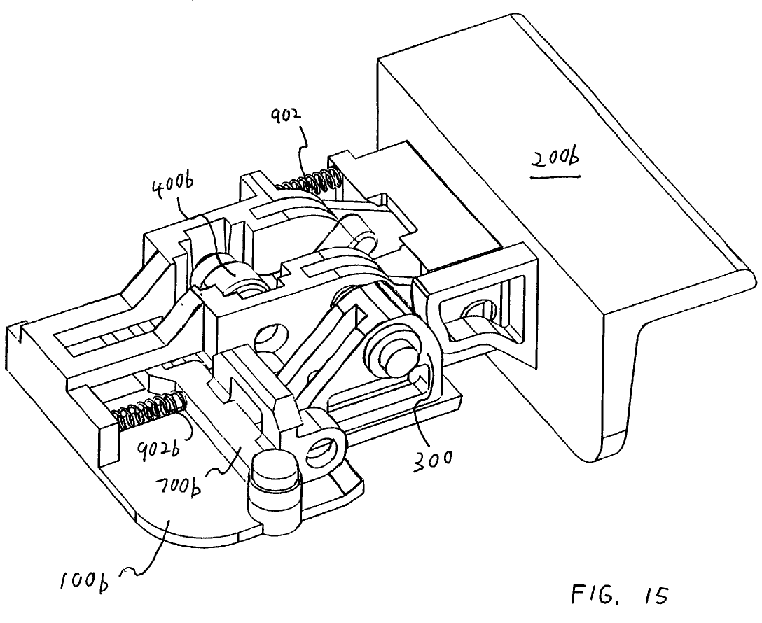

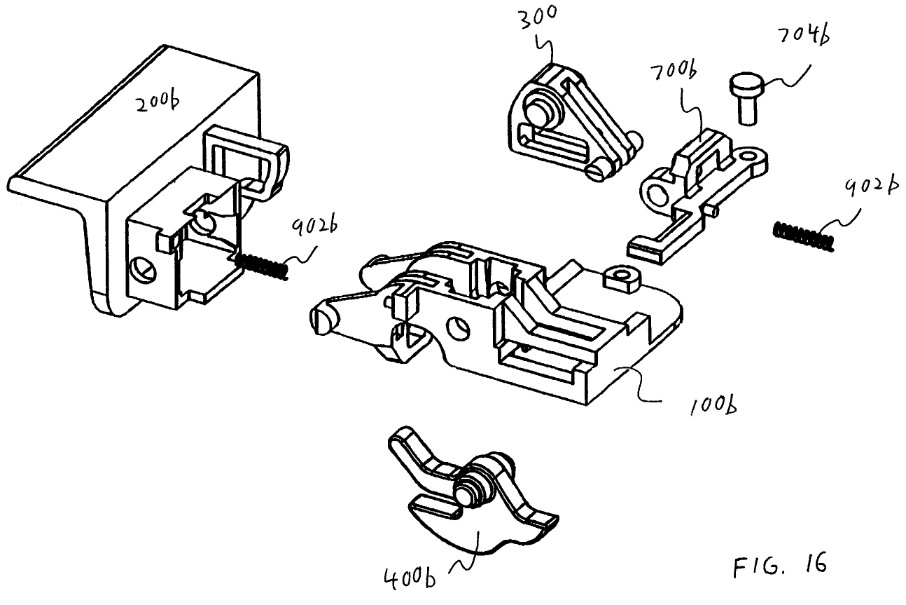

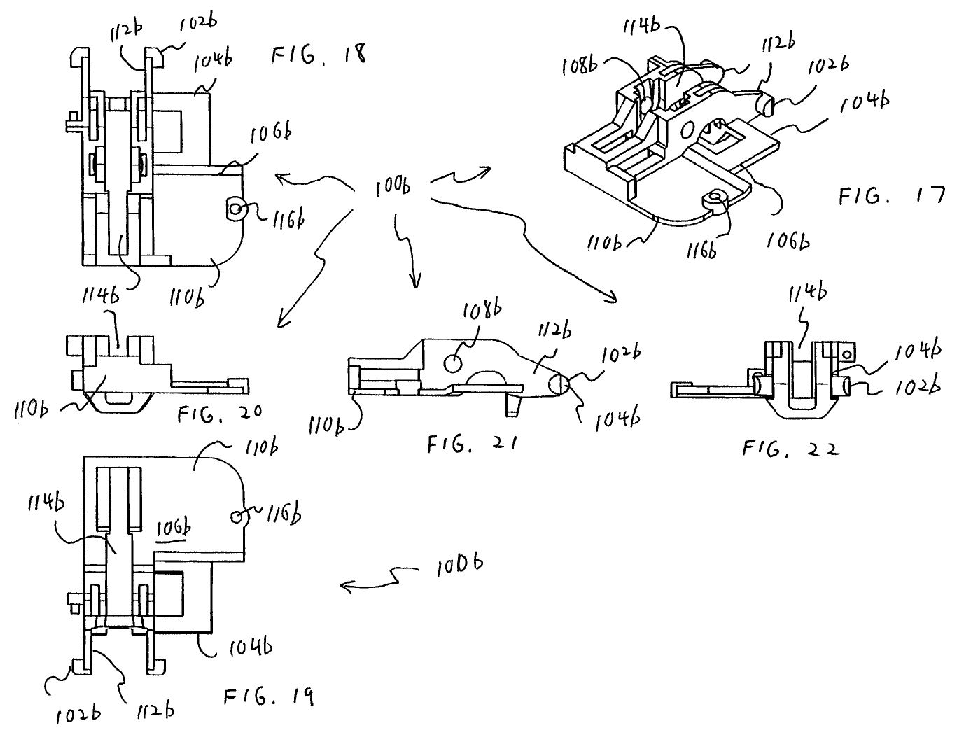

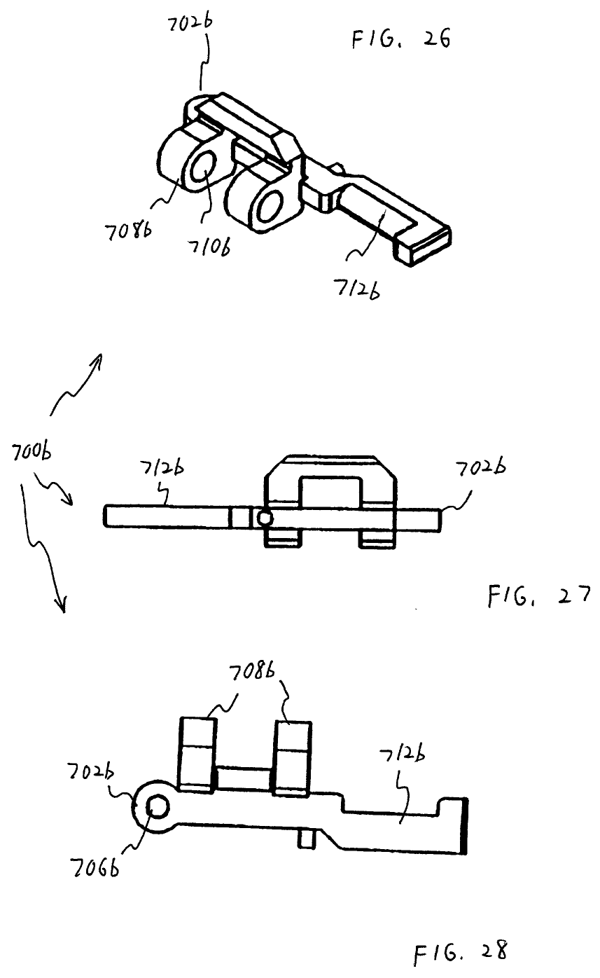

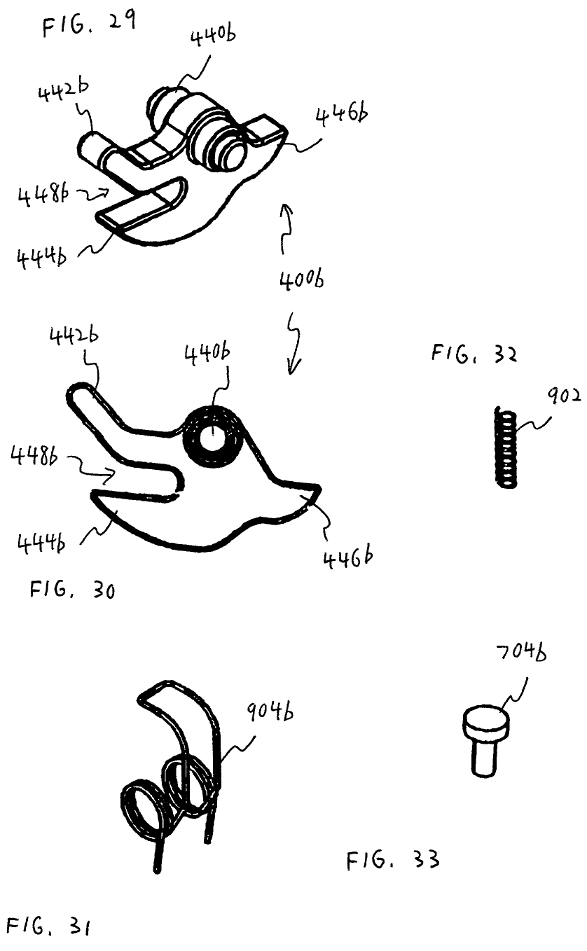

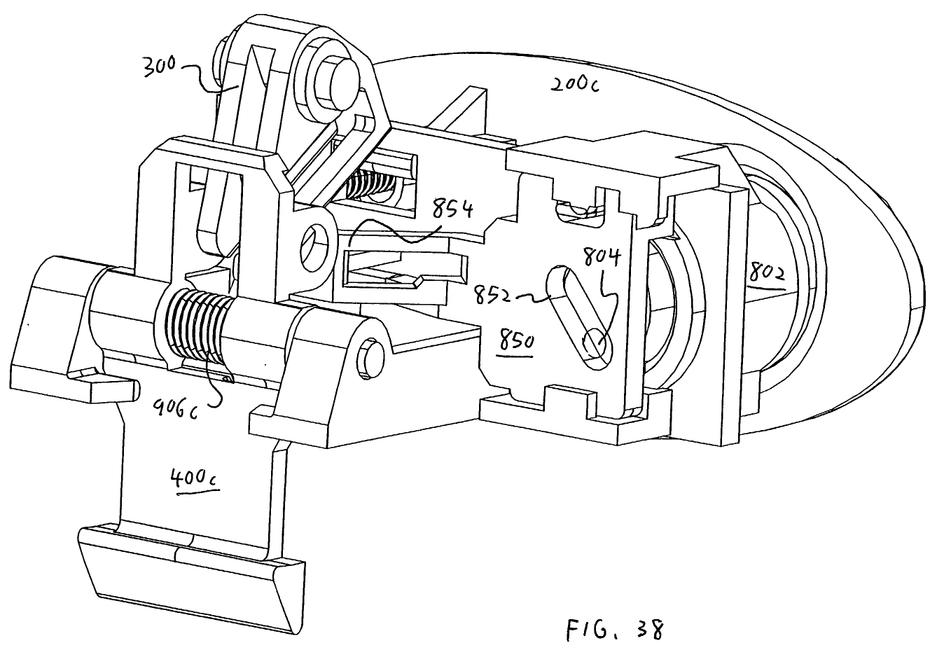

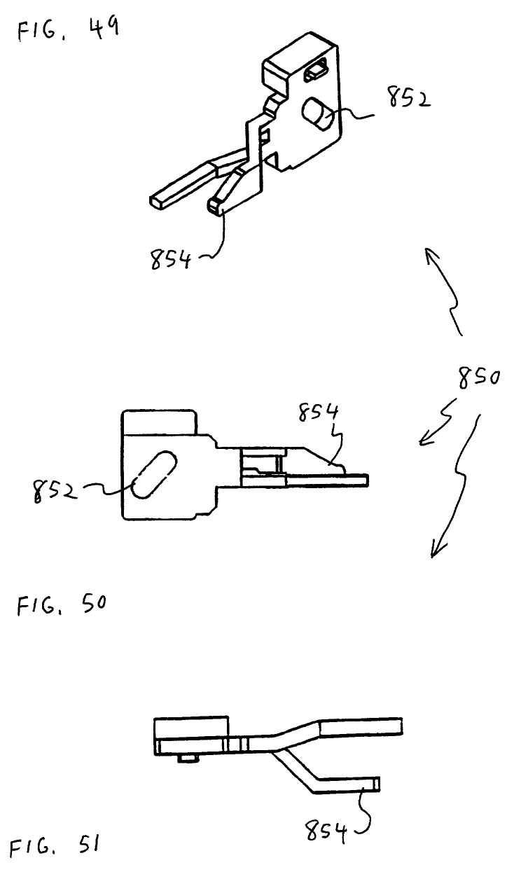

The invention is a gravity-sensitive latch. When the latch is in a first orientation, such as horizontal, the latch may be actuated. When the latch is in a second orientation, preferably vertical, the latch cannot be actuated. Referring to the FIGURES, the latch 10 includes a housing 100, a handle or button 200, a pendulum 300, a pawl 400 dimensioned and configured to engage a keeper, and means for connecting the pendulum to the pawl. Components of specific embodiments of the invention will be referred to herein by reference numbers including a lowercase letter, for example, 10a for a first embodiment of a latch. Components included in all embodiments will be referred to by reference numbers by themselves. A first preferred embodiment of a latch is illustrated in FIGS. 1-11, a second preferred embodiment is illustrated in FIGS. 15-33, and a third preferred embodiment is illustrated in FIGS. 33-57.

Referring to FIGS. 12-14, a preferred and suggested pendulum 300, used within all embodiments of the invention, is illustrated. A preferred and suggested pendulum 300 is triangular in shape, having a connection corner 302, a weighted corner 304, and an abutment corner 306 dimensioned and configured to abut a corresponding surface of the handle or button. The connection corner 302 includes means for pivotally securing the pendulum 300 to a pawl or pawl assembly, with preferred and suggested means being a pair of pegs 308 extending perpendicular to the pendulum. The weighted corner 304 has significantly more mass than the remainder of the pendulum 300, ensuring that gravity acting on the pendulum 300 will primarily act on this weighted corner 304. The abutment corner 306 provides a generally flat surface area for abutting a flange extending rearward from a button or handle, as described below.

Referring to FIGS. 6-8, a housing 100a for a first embodiment of the present invention is preferably rectangular and elongated, having a top 102a, bottom 104a, a pair of sides 106a, a front end 108a, and a back or rear end 110a. The top 102a is substantially open within the housing's front portion 112a, and the bottom 104a is substantially open within the rear portion 114a. The housing includes a front end 108a dimensioned and configured to receive a button, preferably including a central aperture 116a and a pair of slots 118a on either side, with another aperture 120a on each side 106a, adjacent to the slots 118a.

A button 200a for a first embodiment of a latch is illustrated in FIG. 9. The button 200a includes a body 202a having a front surface 204a. A short, wide shaft 206a protrudes from the rear of the button, and is dimensioned and configured to fit within the central aperture 116a of the housing's front 102a. The button includes means for securing to the housing, preferably in the form of flanges 208a on either side of the shaft, dimensioned and configured to fit within the slots on the housing's front, and having apertures 210a, corresponding to the apertures 120a in the housing. A pin (not shown, and well-known) inserted through both the apertures 210a and 120a will thereby secure the button 200a within the housing 100a. When the button is installed on a latch, the end of the central shaft 206a will pass through the aperture 116a to abut the abutment corner 306 of the pendulum 300. The button is spring-biased away from the housing, preferably by a spring 900, illustrated in FIG. 10, surrounding the central shaft 206a, towards its forward position.

The pendulum 300 is pivotally secured to a connecting rod 500a, illustrated in FIG. 11. The connecting rod 500a includes one end having means for pivotally securing the pawl 300, which are preferably a pair of flanges 502a defining a pair of apertures 504a, with the apertures 504a being dimensioned and configured to receive the pegs 308. The opposite end 506a is secured to a pawl 400a, thereby forming part of a reciprocating pawl assembly 508a. The weighted corner 304 of the pendulum 300 is preferably oriented upward. The pawl 400a and corresponding keeper 600a are best illustrated in FIGS. 1-5. A preferred and suggested pawl 400a is configured as a box having a bottom 402a, a top surface 404a, a back or rear end 406a, a front end 408a, to which the connecting rod 500a is secured, and a pair of sides 410a. The bottom 402a includes a pawl-engaging aperture 412a. A preferred and suggested pawl 400a has a bottom 402a as a separate component, securing to the rest of pawl 400a using an upward flange 414a, having an aperture 416a. The back 406a includes a shaft 418a, dimensioned and configured to fit within the aperture 416a. The pawl is secured to the housing by a pawl-retaining bracket 420a, with the pawl-retaining bracket having a second pawl-engaging aperture 422a substantially the same as the pawl's aperture 412a, and located adjacent to the aperture 412a. A ring 430a extends upward from the aperture 422a, corresponding in height to a forward flange 432a extending downward from the bottom 402a. The pawl-retaining bracket 420a preferably includes a second aperture 424a, dimensioned and configured to receive the shaft 418a. The pawl-retaining bracket also preferably includes a forward flange 426a defining an aperture 428a, dimensioned and configured to guide the connecting rod 500a. The pawl 400a reciprocates between a latched position wherein the two apertures 412a, 422a are slightly offset from each other, and an unlatched position wherein the apertures 412a, 422a are aligned with each other. The pawl is spring-biased towards its latched position, preferably by a spring (not shown) surrounding the shaft 418a. A second spring (not shown) preferably extends downward from the top of the pawl's box.

A keeper 600a corresponding to the first embodiment of the latch 10a will typically include a cylindrical shaft 602a having a channel 604a around its upper end. The tip 606a of the keeper has a tapered configuration. The cylindrical shaft 602a will be secured to a mounting bracket 608a. Typically, the latch will be secured to a lid, and the keeper will be secured to the frame surrounding the lid.

Latching the latch 10a is accomplished by inserting the keeper 600a into the two apertures 412a, 422a in the pawl 400a and flange 420a. The tapered tip 606a of the keeper will bias the pawl 400a towards its unlatched position, allowing the keeper 600a to enter the pawl 400a. The pawl's upper spring is thereby compressed. Once the keeper's channel 604a is even with the pawl's bottom surface 402a, the pawl 400a moves under spring pressure towards its latched position, thereby trapping the keeper's channel 604a between the edge of the pawl's aperture 412a and the edge of the pawl retaining flange's aperture 422a.

When the latch 10a is in its horizontal position, the pendulum 400a abuts the central shaft 206a of the button 200a, so that a rearward push on the button 206a pushes rearward on the pendulum 300. The connecting rod 500a and pawl 400a are thereby also pushed rearward, releasing the keeper's channel 604a from between the pawl aperture 412a and pawl flange's aperture 422a. The pawl's top spring then pushes the keeper 600a out of the latch 10a.

When the latch 10a is in its vertical position, the pendulum 300 pivots away from the button 200a through gravity acting on the pendulum's weighted corner 304. When the button 200a is pressed rearward, it is thereby prevented from actuating the latch 10a. Rotating the latch 10a into a horizontal position will again pivot the pendulum 300 into engagement with the button's central shaft 206a, permitting actuation of the latch 10a.

A second embodiment of a latch 10b according to the present invention, illustrated in FIGS. 15-33, uses a housing 100b such as one illustrated in FIGS. 17-22. The housing 100b includes means for pivotally securing a handle 200b, which are preferably a pair of pegs 102b, protruding outward from the flanges 112b, with the pegs 102b being dimensioned and configured to fit within corresponding apertures 206b on a handle, located at the front portion 104b of the housing 100b. The central portion 106b of the housing 100b defines a channel 114b, dimensioned and configured to receive a pawl 400b and a keeper 600b, described below. The channel 114b includes a pair of apertures 108b, dimensioned and configured to pivotally secure a pawl 400b within the housing. The rear portion 110b of the housing 100b includes an aperture 116b dimensioned and configured to receive the pin 704b, described below.

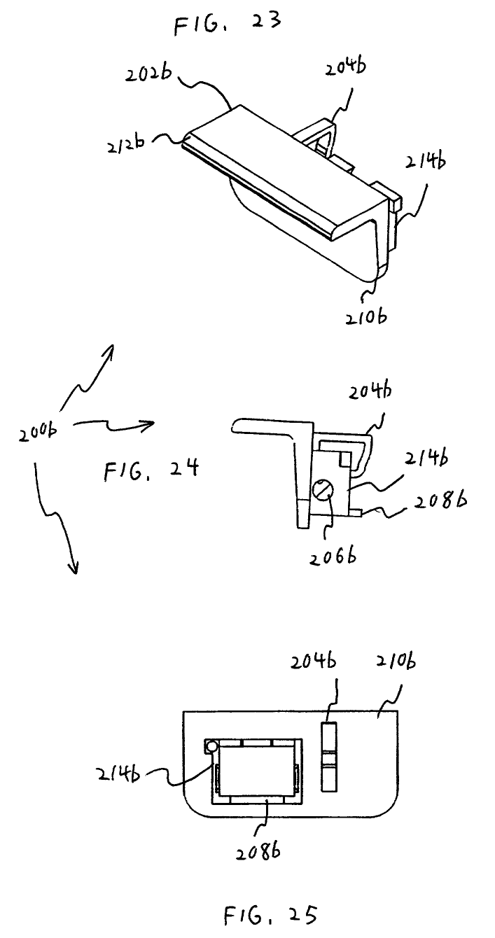

The latch 10b uses a handle 200b that is pulled to actuate the latch, instead of a button to be pushed. The handle 200b, illustrated in FIGS. 23-25, is preferably L-shaped when viewed from either side 202b, including a vertical portion 210b and a horizontal portion 212b. The handle 200b includes means for pivotally securing to the housing 100b, preferably in the form of apertures 206b, defined within the flanges 214b protruding from the vertical portion 210b, and a rearward projecting flange 204b dimensioned and configured to abut the pendulum. The handle 200b preferably includes a stop 208b to prevent travel beyond the desired range of motion. The handle 200b pivots between a latched position and an unlatched position, and is spring-biased towards its latched position, preferably by the spring 902. A preferred handle 200b has the apertures 206b positioned below the flange 204b and spring 902, so that lifting up on the horizontal portion 212b will compress the spring 902 (FIG. 32) and move the flange 204b rearward.

The pendulum 300 is pivotally secured to a pawl-retaining arm 700b, illustrated in FIGS. 26-28. The pawl-retaining arm 700b is pivotally secured to the housing 100b at its end 702b adjacent to the pawl, preferably by pin 704b (FIG. 33) passing through the aperture 706b within the pawl-retaining arm 700b and into the corresponding aperture within the housing 100b. The pawl-retaining arm 700b is thereby permitted to pivot between a latched position and an unlatched position. The pawl-retaining arm 700b includes means for pivotally securing the pendulum 300, which are preferably a pair of flanges 708b, each defining an aperture 710b, dimensioned and configured to receive the pendulum's pegs 308. The pawl-retaining arm's opposite end 712b is dimensioned and configured to engage a pawl 400b, as described below. The pawl-retaining arm is spring-biased towards its latched position, preferably by a second spring 902, wherein it engages the pawl 400b.

A preferred pawl 400b is illustrated in FIGS. 29-30. The pawl 400b includes means for pivotally securing to the housing 100b, which are preferably a pair of pins 440b, dimensioned and configured to fit within the apertures 108b. The pawl includes an upper forward arm 442b, a lower forward arm 444b, defining a channel 448b therebetween, and a rearward arm 446b. The rearward arm 446b is dimensioned and configured to engage the pawl-retaining arm 700b. The channel 448b is dimensioned and configured to secure a keeper 600b, which will typically be an inverted U-shaped wire or rod. The pawl 400b pivots between a latched position wherein the two forward arms 442b, 444b are substantially horizontal, and an unlatched position wherein the two forward arms 442b, 444b point downward. The pawl 400b is spring-biased towards its unlatched position, preferably by a pawl spring 904b as illustrated in FIG. 31.

Typically, the latch 10b will be secured to a lid, and the keeper 600b will be secured to a frame surrounding the lid. When the lid is closed and the keeper 600b enters the housing 100b, it engages the upper forward arm 442b of the pawl 440b, pushing the pawl 400b towards its horizontal position. As the pawl 400b rotates, the pawl's rearward arm 446b pushes the pawl retaining arm 700b rearward, permitting the pawl 400b to rotate into a horizontal position. Once the pawl 400b is horizontal, the pawl-retaining arm 700b moves forward under spring pressure, to a position under the pawl's rear arm 446b. The keeper 600b is thereby secured within the channel 448b, and by the channel 114b in the housing 100b.

The unlatching of the latch 10b is controlled by the position of the pendulum 300. When the latch 10b is in its horizontal position, the pendulum 300 abuts the handle 200b, so that an upward pull on the handle 200b will push the pendulum 300 rearward. The pawl-retaining arm 700b will thereby also be pushed rearward, releasing the pawl 400b to rotate under spring pressure towards its unlatched position. The keeper 600b can then exit the latch 10b. When the latch 10b is in its vertical position, the pendulum 300 rotates away from the handle 200b, so that a pull on the handle 200b does not push rearward on the pendulum 300. Rotating the latch 10b back to its horizontal position causes the pendulum 300 to again rotate so that it abuts the handle 200b, permitting actuation of the latch 10b.

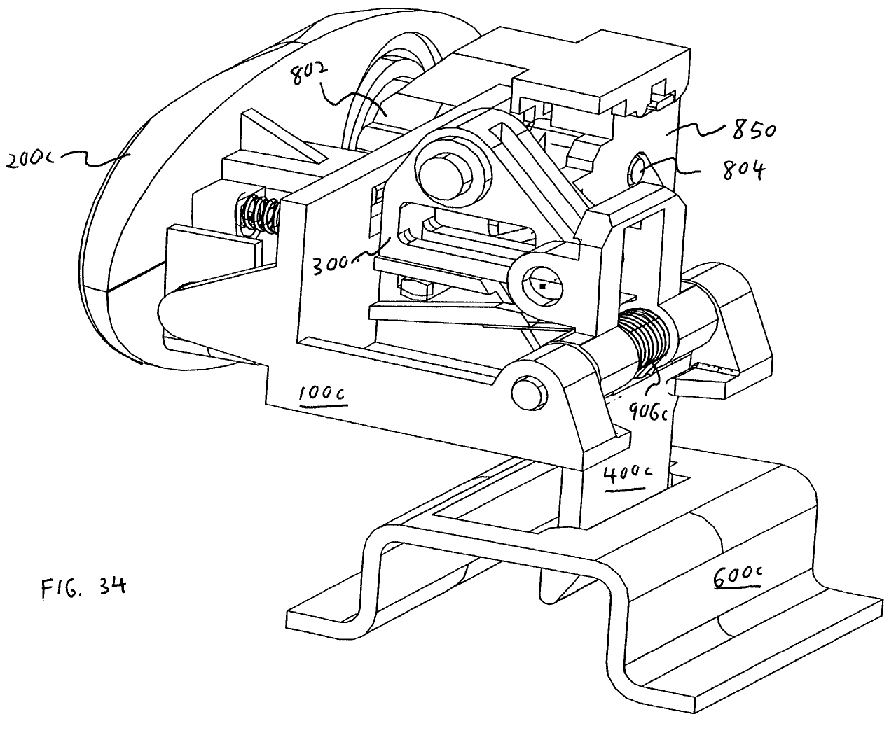

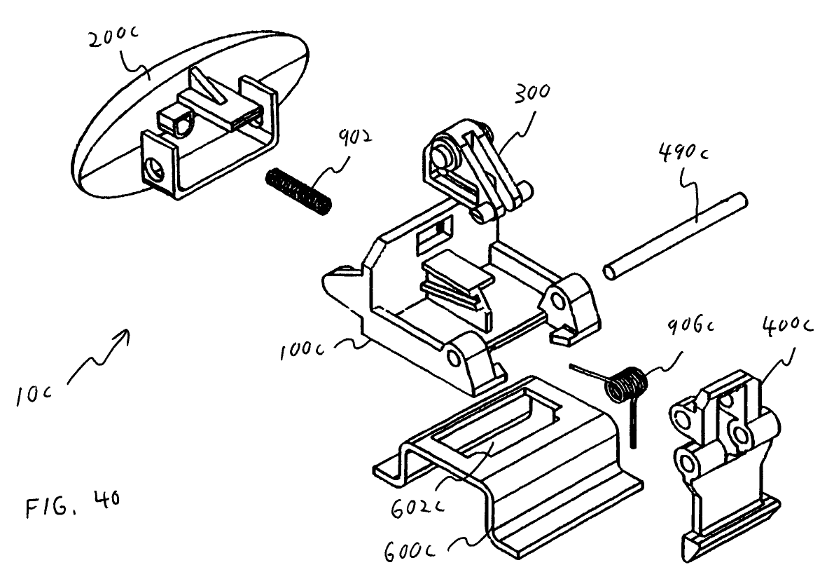

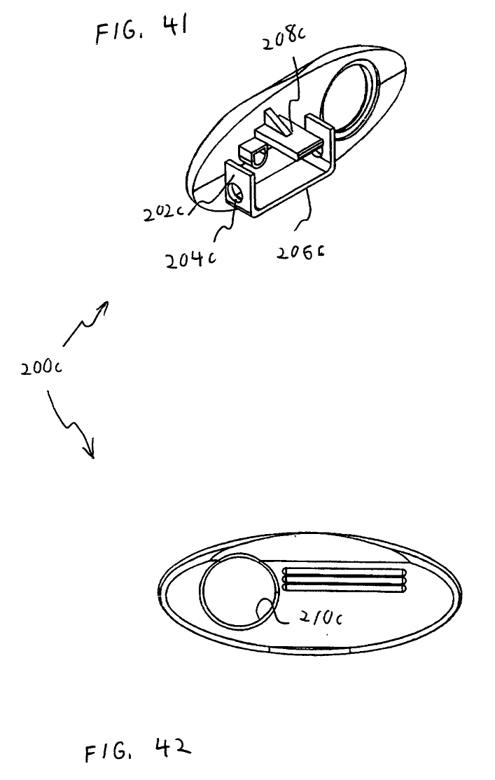

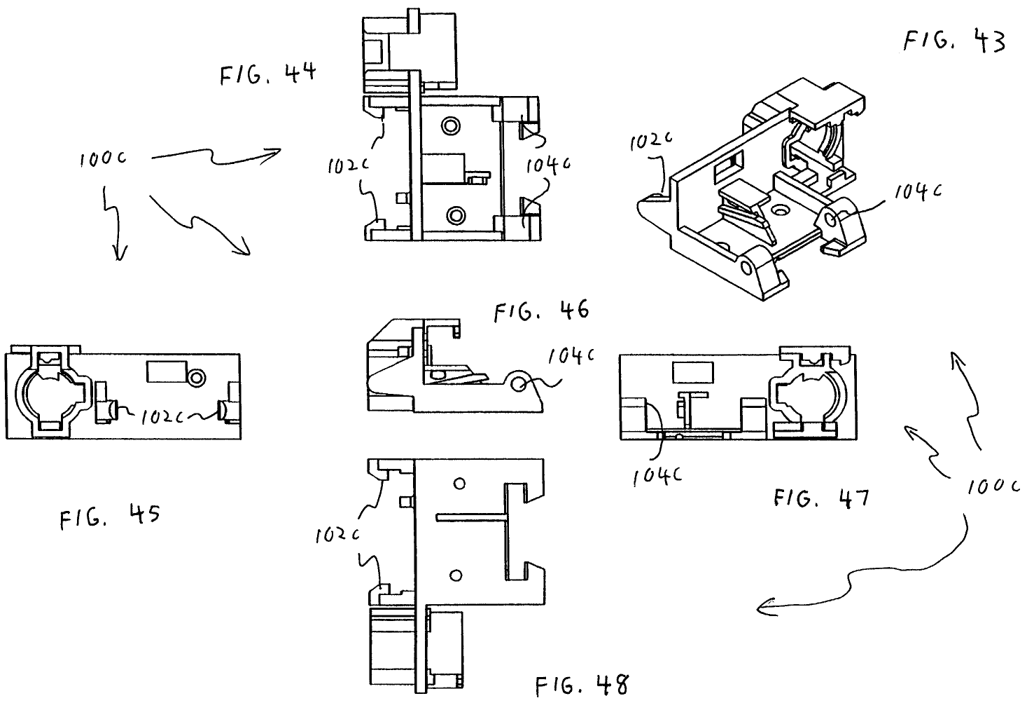

A third embodiment of the latch 10c is illustrated in FIGS. 34-57. The housing 100c is illustrated in FIGS. 43-48. The front of the housing includes means for securing a button, which is preferably a pair of pegs 102c. The rear portion of the housing defines means for pivotally securing a pawl 400c, which preferably include a pair of flanges defining a pair of apertures 104c dimensioned and configured to receive a pivot rod 490c, illustrated in FIG. 57.

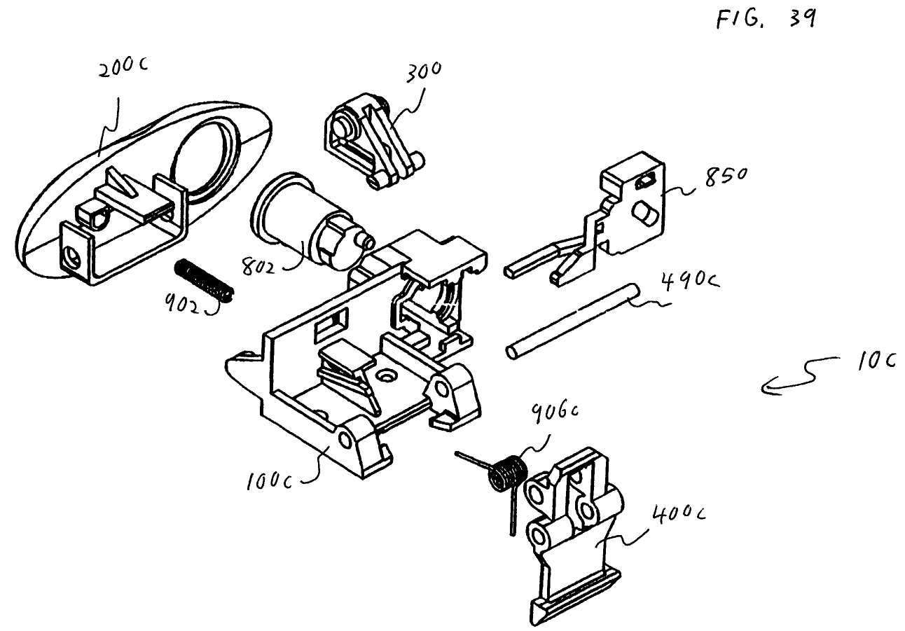

The latch 10c is actuated by depressing a button 200c, illustrated in FIGS. 41-42. The button 200c includes means for pivotally securing to the housing, preferably including a flange 202c protruding from the button's rear, with the flange 202c defining a pair of apertures 204c, dimensioned and configured to receive the pegs 102c of the housing 100c. The button 200c also includes a flange 208c for abutting the pendulum, and a flange 206c for limiting travel of the button. The button is spring-biased forward, away from the housing, preferably by a spring 902. The button may include an aperture 210c, dimensioned and configured to receive a lock 800, described below.

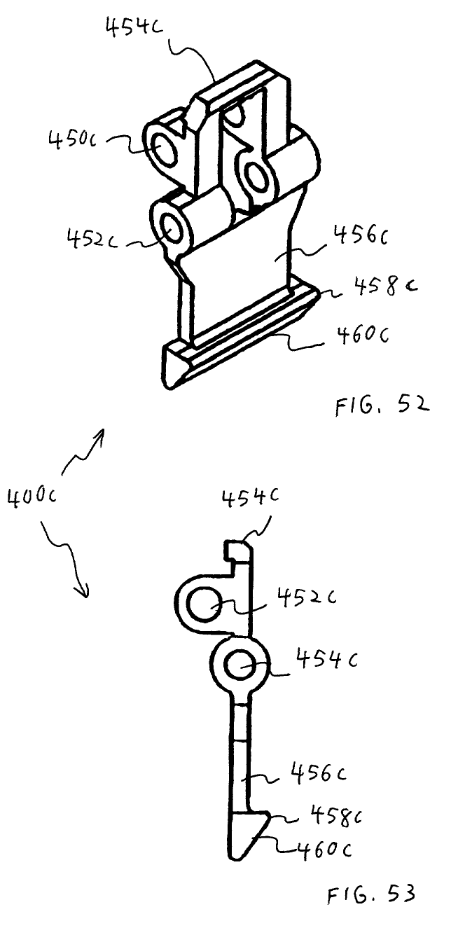

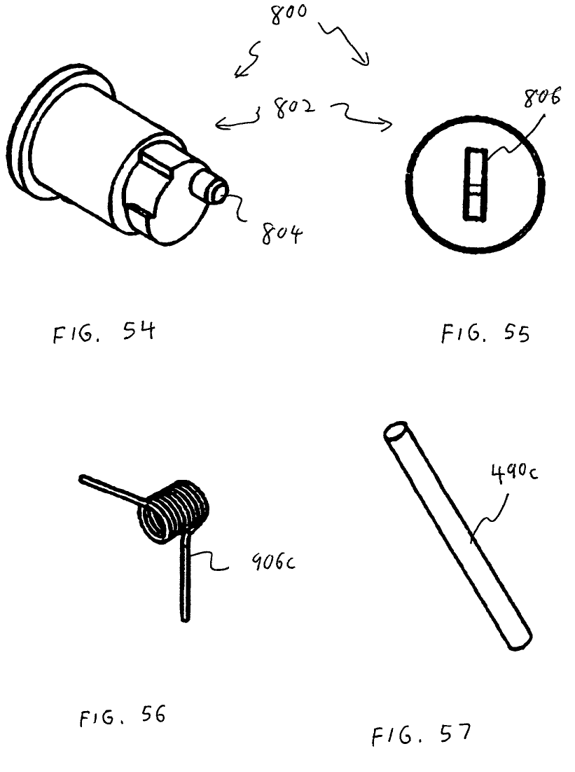

The pendulum 300 is secured directly to the upper end of a pawl 400c, illustrated in FIGS. 52-53. The pawl includes an upper end 454c, and a lower end 456c. The upper end 454c of the pawl 400c includes means for pivotally securing the pendulum 300, which preferably include a pair of apertures 450c dimensioned and configured to receive the pegs 308 of the pendulum. The central section of the pawl defines means for pivotally securing the pawl to the housing, preferably at least one aperture 452c, dimensioned and configured to receive the rod 490c. The rod 490c passing through the apertures 452c and 104c thereby pivotally secures the pawl 400c vertically on the housing 100c. The lower end 456c includes a hook 458c, dimensioned and configured to engage a keeper 600c. The lower portion of the hook 458c includes a ramped portion 460c. The pawl pivots between a latched position wherein the lower end 456c is rearward, and an unlatched position wherein the lower end 456c is forward. It is now apparent that a rearward push on the pawl 400c by the pendulum 300 pushes the pawl's lower end 456c forward towards its unlatched position. The pawl 400c is spring-biased towards its rearward latched position, preferably by a spring 906c, illustrated in FIG. 56.

Typically, the latch 10c will be secured to a lid, and the keeper 600c will be secured to a frame surrounding the lid. A preferred keeper 600c is a plate having an opening 602c dimensioned and configured to receive the pawl's hook 458c. When the latch 10c is closed, the pawl's ramp 460c strikes the keeper 600c, pushing the lower end 456c of the pawl 400c forward and allowing the pawl 400c to enter the keeper's opening 602c. Once the pawl's lower end 456c clears the edge of the keeper 600c, the pawl 400c returns to its latched position under spring pressure, latching the latch 10c.

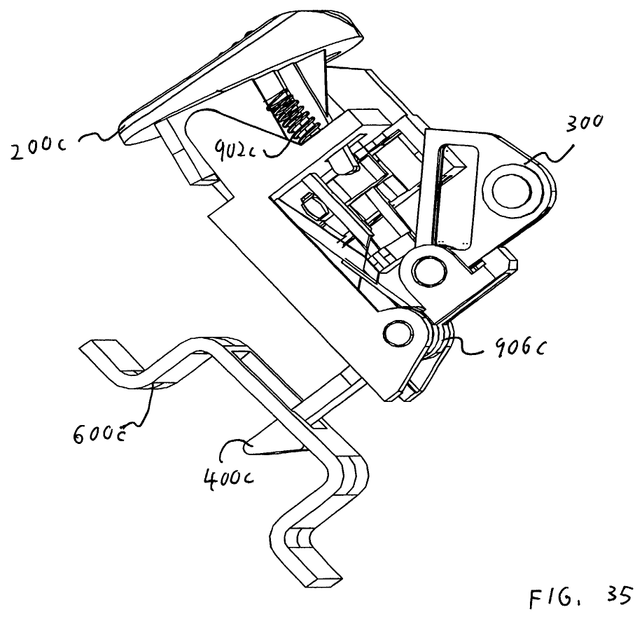

Unlatching of the latch 10c is controlled by the position of the pendulum 300. When the latch 10c is in its horizontal position, as illustrated in FIG. 34, the pendulum 300 is rotated to engage the button 200c. Depressing the button 200c will therefore push rearward on the pendulum 300 and the upper end 454c of the pawl 400c, unlatching the latch 10c. When the latch 10c is in a vertical orientation, illustrated in FIG. 35, the pendulum 300 pivots away from the button 200c, so that pressing the button 200c will not unlatch the latch 10c. Rotating the latch 10c to its horizontal orientation will again rotate the pendulum 300 to abut the button 200c, permitting actuation of the latch 10c.

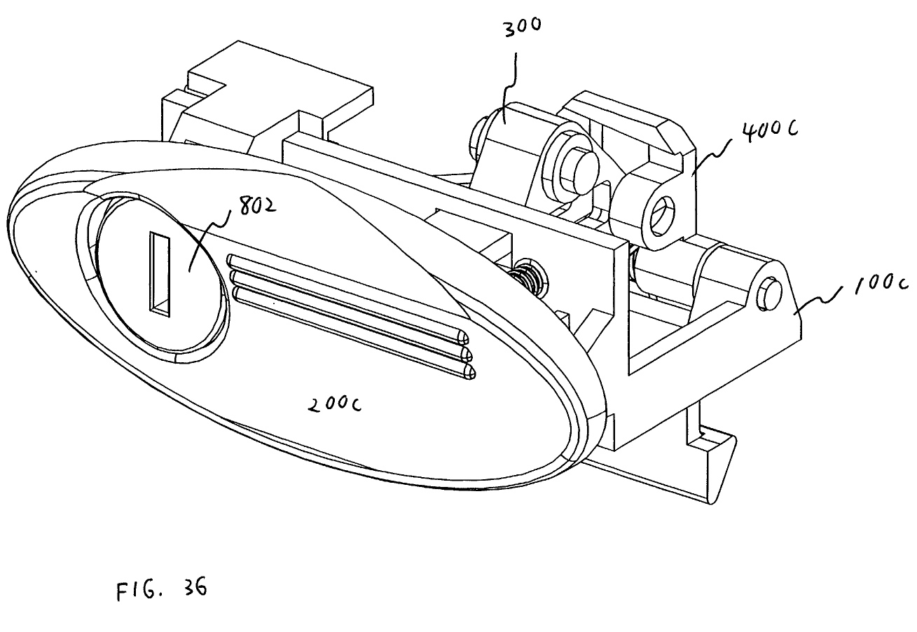

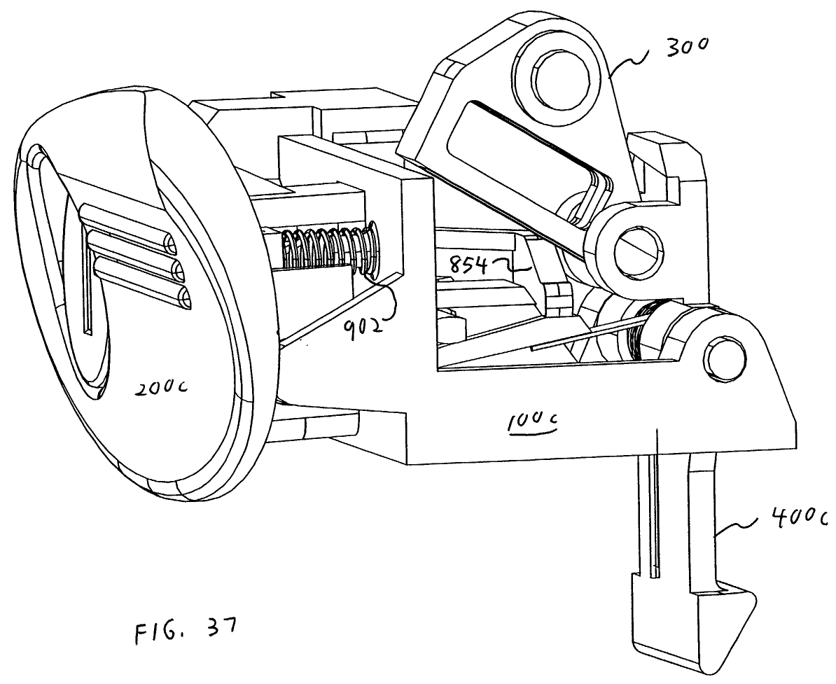

Any of the preferred latches 10 may include a lock 800 for preventing actuation of the latch 10 regardless of its orientation. A preferred and suggested lock 800 includes a standard lock plug 802 (FIGS. 54-55) having a pin 804 at its rear end, and a keyhole 806 at its front end. A locking arm 850 (FIGS. 49-51) is slidably mounted to the rear of the lock plug 802. The locking arm 850 includes a diagonal slot 852 at one end, dimensioned and configured to receive the pin 804 of the lock plug 802. The opposite end of the locking arm 850 includes a ramp 854 dimensioned and configured to push the pendulum 300 out of engagement with the button or handle 200. Turning the key in the lock plug 802 rotates the pin 804, thereby pushing the locking arm 850 under the pendulum 300, moving the pendulum 300 away from the button 200, as illustrated in FIGS. 37-38. Turning the key in the opposite direction slides the locking arm 850 away from the pendulum 300, thereby removing the locking arm 850 from engagement with the pendulum 300 and permitting free rotation of the pendulum 300, as illustrated in FIG. 36.

It is to be understood that the invention is not limited to the preferred embodiments described herein, but encompasses all embodiments within the scope of the following claims.

What is claimed is:

1. A gravity-sensitive latch comprising:
a housing;
a button supported for slidable movement relative to said housing;
a pendulum operatively connected to said button, said pendulum pivoting between a latched position and an unlatched position;
a pawl being dimensioned and configured to engage a keeper, said pawl pivoting between a latched position and an unlatched position;
means for securing said housing and said button;
means for pivotally securing said housing and said pawl; and
means for operatively connecting said pendulum and said pawl.

2. The gravity-sensitive latch according to claim 1, wherein said latch can be actuated when said latch is in a horizontal position, and said latch cannot be actuated when said latch is in a vertical position.

3. The gravity-sensitive latch according to claim 1, wherein said housing has a top, a bottom, a pair of sides, a front end, and a rear end.

4. The gravity-sensitive latch according to claim 3, wherein said top of said housing is substantially open within a front portion of said housing, and said bottom of said housing is substantially open within a rear portion of said housing.

5. The gravity-sensitive latch according to claim 3, wherein said front end of said housing is dimensioned and configured for securing to said button.

6. The gravity-sensitive latch according to claim 5, wherein an end of said button abuts said pendulum when said button is installed on said latch.

7. The gravity-sensitive latch according to claim 1, wherein said button is biased away from said housing towards its forward position.

8. The gravity-sensitive latch according to claim 1, wherein said button includes a body having a front surface.

9. The gravity-sensitive latch according to claim 1, wherein said pendulum has a connection corner, a weighted corner, and an abutment corner dimensioned and configured to abut said button.

10. The gravity-sensitive latch according to claim 9, wherein said weighted corner extends upward.

11. The gravity-sensitive latch according to claim 9, wherein said weighted corner has greater mass than the remainder of said pendulum.

12. The gravity-sensitive latch according to claim 9, wherein said pendulum further has at least one peg protruding from said pendulum and said pawl has at least a corresponding aperture for being operatively connected with said pendulum.

13. The gravity-sensitive latch according to claim 1, wherein said pawl has a bottom, a top surface, a rear end, a front end operatively connected to said pendulum by said means for operatively connecting said pendulum and said pawl, and a pair of sides.

14. The gravity-sensitive latch according to claim 13, wherein said bottom of said pawl has a pawl-engaging aperture and said means for pivotally securing said housing and said pawl is a pawl-retaining bracket, said bracket has a pawl-engaging aperture that is substantially the same as and located adjacent to said pawl-engaging aperture of said bottom of said pawl.

15. The gravity-sensitive latch according to claim 13, wherein a biasing means extends downward from the top of said pawl.

16. The gravity-sensitive latch according to claim 1, wherein said pawl is biased towards its latched position.

17. The gravity-sensitive latch according to claim 1, wherein said means for securing said housing and said button is a pin.

18. The gravity-sensitive latch according to claim 1, wherein said means for operatively connecting said pendulum and said pawl is a connecting rod.

19. The gravity-sensitive latch according to claim 1, further comprising a keeper adapted for engaging with said pawl.

20. The gravity-sensitive latch according to claim 19, wherein said keeper is a cylindrical shaft having a channel around its upper end.

21. The gravity-sensitive latch according to claim 20, wherein said upper end of said keeper has a tip and a tapered configuration.

22. The gravity-sensitive latch according to claim 20, wherein said pawl has a bottom having a pawl-engaging aperture, said means for pivotally securing said housing and said pawl is a pawl-retaining bracket, said bracket has a pawl-engaging aperture that is substantially the same as and located adjacent to said pawl-engaging aperture of said bottom of said pawl, said latch is latched by inserting said keeper into said pawl-engaging apertures in said pawl and said bracket whereby causing said upper end of said keeper to bias said pawl towards its unlatched position so as to allow said keeper to enter said pawl.

23. A gravity-sensitive latch comprising:
a housing;
a handle pivotally secured to said housing, said handle pivoting between a latched position and an unlatched position;
a pawl pivotally secured to said housing, said pawl being dimensioned and configured to engage a keeper, said pawl pivoting between a latched position and an unlatched position;
a pawl-retaining arm pivoting between a latched position and an unlatched position;
a pendulum pivotally secured to said pawl-retaining arm, said pendulum being dimensioned and configured to abut said handle, said pendulum pivoting between a latched position and an unlatched position; and
means for pivotally securing said housing and said pawl-retaining arm.

24. The gravity-sensitive latch according to claim 23, wherein said latch can be actuated when said latch is in a horizontal position, and said latch cannot be actuated when said latch is in a vertical position.

25. The gravity-sensitive latch according to claim 23, wherein said housing is dimensioned and configured to receive a keeper.

26. The gravity-sensitive latch according to claim 23, wherein:
said housing includes a front end, a central portion defining a channel dimensioned and configured to receive said pawl and a keeper, and a rear portion dimensioned and configured to receive a pin, said channel dimensioned and configured to pivotally secure said pawl within said housing; and
said handle includes a vertical portion, a horizontal portion, and a rear end dimensioned and configured to engage with said front end of said housing.

27. The gravity-sensitive latch according to claim 26, wherein said handle includes a rearward-projecting structure for abutting said pendulum and said handle is biased towards its latched position by biasing means wherein the engagement portion of said rear end of said handle that engages with said front end of said housing is positioned below said rearward-projecting flange and said biasing means.

28. The gravity-sensitive latch according to claim 23, wherein said handle includes a rearward-projecting structure for abutting said pendulum.

29. The gravity-sensitive latch according to claim 23, wherein said handle includes a stop to prevent travel beyond a predetermined range of motion.

30. The gravity-sensitive latch according to claim 23, wherein said handle is biased towards its latched position.

31. The gravity-sensitive latch according to claim 23, wherein said pawl-retaining arm is biased towards its latched position.

32. The gravity-sensitive latch according to claim 23, wherein said pawl-retaining arm is pivotally secured to said housing at its end adjacent to said pawl.

33. The gravity-sensitive latch according to claim 23, wherein said pendulum has a connection corner, a weighted corner, and an abutment corner dimensioned and configured to abut said handle.

34. The gravity-sensitive latch according to claim 33, wherein said weighted corner extends upward.

35. The gravity-sensitive latch according to claim 33, wherein said weighted corner has greater mass than the remainder of said pendulum.

36. The gravity-sensitive latch according to claim 23, wherein said pawl-retaining arm includes a first end having at least one flange defining at least one aperture and a second end dimensioned and configured to engage said pawl, said pendulum has at least one peg protruding from said pendulum, said at least one aperture of said first end is dimensioned and configured to receive said peg of said pendulum.

37. The gravity-sensitive latch according to claim 23, wherein said pawl includes an upper forward arm and a lower forward arm extending toward said handle, a channel between said forward arms, and a third arm extending rearward, said third arm is dimensioned and configured to engage said pawl-retaining arm, said forward arms are dimensioned and configured to secure a keeper, said pawl pivots between said latched position wherein said forward arms are substantially horizontal, and said unlatched position wherein said forward arms point downward.

38. The gravity-sensitive latch according to claim 23, wherein said pawl is biased towards its unlatched position.

39. The gravity-sensitive latch according to claim 23, wherein said means for pivotally securing said housing and said pawl-retaining arm is a pin.

40. The gravity-sensitive latch according to claim 23, further comprising a keeper adapted for engaging with said pawl.

41. A gravity-sensitive latch comprising:
a housing;
a button supported for slidable movement relative to said housing, said button secured to said housing;
a pendulum operatively connected to said button, said pendulum pivoting between a latched position and an unlatched position;
a pawl pivotally secured to said pendulum, said pawl being dimensioned and configured to engage a keeper, said pawl pivoting between a latched position and an unlatched position; and
means for pivotally securing said housing and said pawl.

42. The gravity-sensitive latch according to claim 41, wherein said latch can be actuated when said latch is in a horizontal position, and said latch cannot be actuated when said latch is in a vertical position.

43. The gravity-sensitive latch according to claim 41, wherein said housing includes a front end dimensioned and configured for securing to said button, and a rear portion dimensioned and configured for securing to said pawl.

44. The gravity-sensitive latch according to claim 41, wherein said button includes a structure for abutting said pendulum.

45. The gravity-sensitive latch according to claim 41, wherein said button includes a stop to prevent travel beyond a predetermined range of motion.

46. The gravity-sensitive latch according to claim 41, wherein said button is biased away from said housing towards its forward position.

47. The gravity-sensitive latch according to claim 41, wherein button is dimensioned and configured to receive a lock.

48. The gravity-sensitive latch according to claim 41, wherein said pendulum has a connection corner, a weighted corner, and an abutment corner dimensioned and configured to abut said button.

49. The gravity-sensitive latch according to claim 48, wherein said weighted corner extends upward.

50. The gravity-sensitive latch according to claim 48, wherein said weighted corner has greater mass than the remainder of said pendulum.

51. The gravity-sensitive latch according to claim 41, wherein said pawl includes an upper end dimensioned and configured for pivotally securing with said pendulum, a lower end dimensioned and configured to engage a keeper, and a central section dimensioned and configured for pivotally securing with said housing.

52. The gravity-sensitive latch according to claim 51, wherein said pawl pivots between said latched position wherein said lower end is rearward, and said unlatched position wherein said lower end is forward.

53. The gravity-sensitive latch according to claim 41, wherein said pawl is biased towards its latched position.

54. The gravity-sensitive latch according to claim 41, wherein said means for pivotally securing said housing and said pawl is a rod.

55. The gravity-sensitive latch according to claim 41, further comprising a keeper.

56. The gravity-sensitive latch according to claim 55, wherein said keeper is a plate having an opening dimensioned and configured to engage with said pawl.

57. The gravity-sensitive latch according to claim 41, further comprising a lock for preventing actuation of said latch regardless of its orientation.
